(19) United States
(12) Patent Application Publication
(10) Pub. No.: US 2010/0172203 A1
(43) Pub. Date: Jul. 8, 2010

(54) MIXING CONTAINER APPARATUS WITH INTERNAL CIRCULATION

(75) Inventor: Vijay Singh, Bernardsville, NJ (US)

Correspondence Address: GE HEALTHCARE BIO-SCIENCES CORP.;PATENT DEPARTMENT, 101 CARNEGIE CENTER, PRINCETON, NJ, 08540, US

(73) Assignee: GE HEALTHCARE BIOSCIENCE BIOPROCESS CORP., PISCATAWAY, NJ (US)

(21) Appl. No.: 12/676,155

(22) PCT Filed: Sep. 15, 2008
(86) PCT No.: PCT/US08/76360

§ 371 Date: Mar. 3, 2010

Related U.S. Application Data
(60) Provisional application No. 60/975,206, filed on Sep. 26, 2007.

(51) Int. Cl. B01F 11/00

(52) U.S. Cl. 366/239

(57) ABSTRACT

This invention is a mixing container apparatus with internal circulation that allows a user to efficiently mix soluble powders or highly viscous liquids in mixing containers. This apparatus utilizes specialized bags with baffles to provide the user with a mixing system that has a good mixing performance. Also, this apparatus allows the mixing apparatus container to preserve its hermetic integrity and does not require any type of seal where the apparatus can be easily scaled up to a few hundred liters. Thus, this invention provides the user with a simple method to mix soluble powder or viscous liquid in a mixing container that is more efficient and provides good mixing performance.

### CROSS-REFERENCE TO RELATED APPLICATIONS

This application is a filing under 35 U.S.C. §371 and claims priority to international patent application number PCT/US2008/076360 filed Sep. 15, 2008, published on Apr. 2, 2009, as WO 2009/042428, which claims priority to U.S. provisional patent application No. 60/975,206 filed on Sep. 26, 2007; the disclosure of which is incorporated herein by reference in its entirety.

### FIELD OF THE INVENTION

The present disclosure relates to hermetically sealed bags containing products used in the pharmaceutical and biotechnology processing industries and, more particularly, to the mixing of such products in situ within the sealed bag.

### BACKGROUND OF THE INVENTION

The bio-processing industry has traditionally used stainless steel systems and piping in manufacturing processes for fermentation and cell culture. These devices are designed to be steam sterilized and reused. Cleaning and sterilization are however costly labor-intensive operations. Moreover, the installed cost of these traditional systems with the requisite piping and utilities is often prohibitive. Furthermore, these systems are typically designed for a specific process, and cannot be easily reconfigured for new applications. These limitations have led to adoption of a new approach over the last ten years—that of using plastic, single-use disposable bags and tubing, to replace the usual stainless steel tanks.

In particular bioreactors, traditionally made of stainless-steel, have been replaced in many applications by disposable bags which are rocked to provide the necessary aeration and mixing necessary for cell culture. These single-use bags are typically sterile and eliminate the costly and time-consuming steps of cleaning and sterilization. The bags are designed to maintain a sterile environment during operation thereby minimizing the risk of contamination.

Bags containing sterile fluids are used in the bioprocessing industry for formulation, storage, transfer, processing, and transportation. Sterile conditions must be maintained during these operations, and the bags are usually sealed to prevent contamination. Commonly used bags are of the “pillow style,” mainly because these can be manufactured at low cost by seaming together two flexible sheets of plastic.

In many applications, the components contained in a bag must be mixed before use. For example, a product may be formulated from the blending of a dry powder into a fluid. In other situations, the product contained in a bag may separate during transport or storage, and require mixing before use.

There are several prior art systems that can mix product within a sealed bio-processing bag. One method utilizes non-invasive wave agitation. To accomplish this, the bio-processing bag is placed in a pan and subject to a controlled rocking motion about a single axis. This rocking motion moves the liquid to and fro in the bag until it is uniformly blended. A second method utilizes a bag with an integral loop of tubing where material is removed from the bag using a peristaltic pump, and then returned to the bag. The fluid circulation through the tube slowly mixes the contents of the bag. A third method utilizes a disposable stirrer that is deposed inside the bag and coupled magnetically to a rotating drive. Another method is to squeeze or undulate the bag sequentially to promote mixing. The last method can only be used for small bags and subjects the bag and its contents to high shear and pressure that could result in damage or a leak.

The rocking action mixing apparatus typically works best with small volumes and is a widely used low cost solution. However, it frequently proves to be unsatisfactory for difficult mixing situations such as the dissolution of poorly soluble powders, or the mixing of highly viscous fluids. It is also difficult to mix large volumes in rocking bags. Bags with pump around loops are not useful in quickly dissolving large amounts of solids and also subject shear-sensitive materials, common in pharmaceutical operations, to damaging fluid shear as the fluid circulates at a high velocity, multiple times through the pump around loop. The use of magnetic stir bars in a bag is very expensive as the stirrer must typically be discarded after a single use. Bags with stir bar mixers cannot be easily scaled up beyond a few hundred liters, limiting general applicability of this method.

Therefore, there is a need for an apparatus that enables a user to efficiently mix soluble powders or highly viscous liquids. Also, there is a need to provide the user with a mixing system that has a good mixing performance and is efficient. Further, there is a need for a mixing system that preserves its hermetic integrity, can be easily scaled up to a few hundred liters, and does not require any type of seal

### SUMMARY OF THE INVENTION

The present invention has been accomplished in view of the above-mentioned technical background, and it is an object of the present invention to provide a system and method that enables a user to efficiently mix soluble powders or highly viscous liquids in a container.

A container for a mixer which rocks the container about a single axis of the container includes top and bottom walls of flexible material joined to form a chamber having a portion of the top and bottom walls joined by side walls and end walls. Baffles are connected to the top and bottom walls at the juncture of the side and end walls and being transverse to the single axis so as to induce a swirling motion of liquids in the chamber when the container is rocked about the single axis.

The baffles each may be located at an oblique juncture of the side and end walls being so as to induce a swirling motion of liquids in the chamber when the container is rocked about the single axis. A first pair of opposed junctures are obtuse angles and a second pair of opposed junctures are acute angles. Alternatively, the baffles each include an arcuate wall of the chamber connecting a side and an end wall. As another alternative, the baffles each include a linear wall of the chamber connecting and oblique to both a side and an end wall.

The top and bottom walls of the container may be seamed together and portions of the top and bottom wall form the side walls of the chamber. The end walls, which are transverse to the single axis, are panels seamed to the top, bottom and side walls so as to define the baffles. The baffles maybe displaced from the side and end walls.

A first pair of baffles may have a first length and a second pair of opposed baffles have a second length shorter than the first length so as to produce a single direction of swirling during rocking. Alternatively, the baffles may each have a substantially shorter length than the length of the end wall so as to produce two swirling patterns during rocking.

A mixer includes a support pivotally mounted to a base about a single axis and a driver connected to the support for rocking the support about the single axis. A container has top and bottom walls joined by side and end walls, and baffles connected to the top and bottom walls at the juncture of the side and end walls. The baffles are transverse to the single axis so as to induce a swirling motion of liquids in the chamber when the container is rocked about the single axis. A clamp secures the container on the support. The container may have the structure of the previously described container.

### BRIEF DESCRIPTION OF THE DRAWINGS

These and other advantages of the present invention will become more apparent as the following description is read in conjunction with the accompanying drawings, wherein:

FIG. 1 shows a perspective view of a pillow style two dimensional bag construction according to the prior art.

FIG. 2 shows a perspective view of the bag of FIG. 1 secured to a rocking platform in accordance with the prior art.

FIG. 3 shows the liquid flow pattern of the bag of FIG. 1 resulting from a single axis of rocking in accordance with the prior art.

FIG. 4 shows a baffled bag and the single liquid flow pattern resulting from a single axis of rocking according to a first embodiment of the invention.

FIG. 5 shows a baffled bag and the single liquid flow pattern resulting from a single axis of rocking according to a second embodiment of the invention.

FIG. 6 shows a baffled bag and the dual liquid flow pattern resulting from a single axis of rocking according to a third embodiment of the invention.

FIG. 7 shows a baffled bag having inflatable flow diversion segments and the liquid flow pattern resulting from a single axis of rocking according to a fourth embodiment of the invention.

FIG. 8 shows a baffled bag with linear baffles and the liquid flow pattern resulting from a single axis of rocking according to a fifth embodiment of the invention.

FIG. 9 shows a trapezoidal shaped baffled bag and the liquid flow pattern resulting from a single axis of rocking according to a sixth embodiment of the invention.

FIG. 10 shows another embodiment with internal flow diversion baffles in accordance with the invention.

FIG. 11 shows a perspective of a three-dimensional bag construction according to another embodiment in accordance with the invention.

FIG. 12 shows a perspective view of the embodiment shown in FIG. 11 showing specific details of the construction.

### DETAILED DESCRIPTION OF THE INVENTION

The presently preferred embodiments of the invention are described with reference to the drawings, where like components are identified with the same numerals. The descriptions of the preferred embodiments are exemplary and are not intended to limit the scope of the invention.

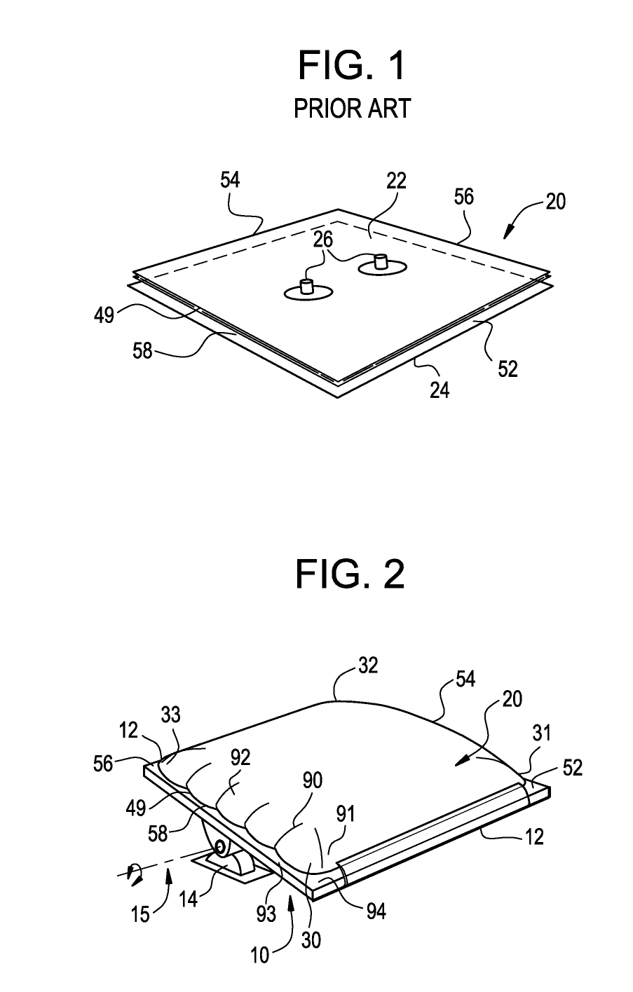

A prior art bag 20, as shown in FIG. 1, is a flat, rectangular, “pillow-style” cell culture bag 20 commonly used in rocking bioreactor applications, for example in the system of U.S. Pat. No. 6,190,913, entitled “Method for Culturing Cells Using Wave-Induced Agitation” filed Aug. 12, 1998, which is hereby incorporated by reference. The bag 20 is formed by seaming together, by the typical seaming method, top sheet 22 to bottom sheet 24. An outline seam 49 formed by sealing the two sheets 22 and 24 together at all four edges 52, 54, 56, and 58 which bounds an inside chamber in which culture fluids 32 are contained. Ports 26 on top sheet 22 are used for the introduction and exhaust of gases.

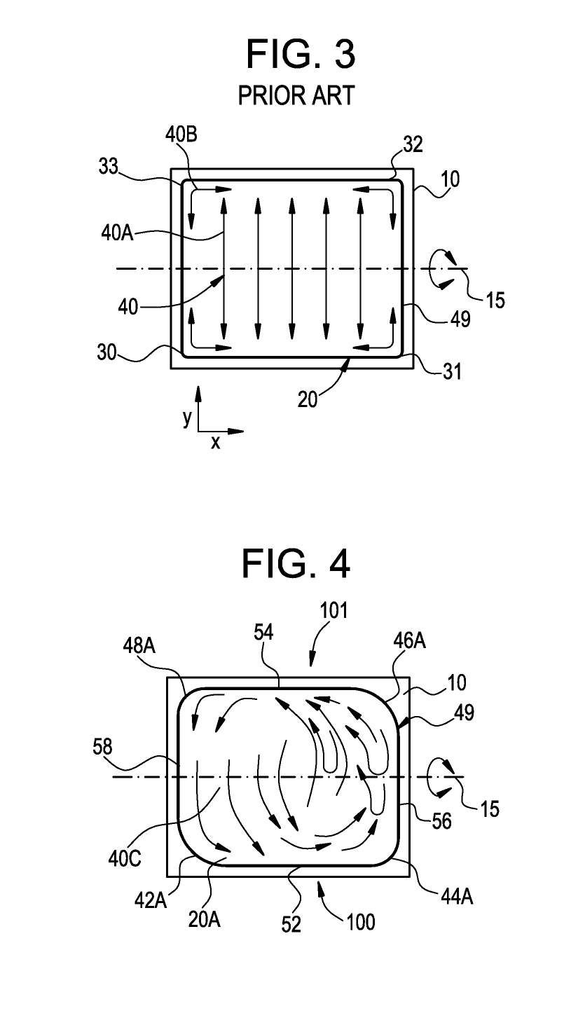

FIG. 2 shows a bag 20 secured to a support 10 of a rocking platform using clamps 12 on side edges 52 and 54. The support 10 is pivotable mounted to a base 14 and is rocked about a single axis 15. The fluid flow induced by the rocking is depicted in FIG. 3 as streamlines 40. As shown, the rocking motion generates fluid motion 40A mainly along the Y-axis (perpendicular to rocking axis 15). Very little fluid motion 40B in the X-direction (parallel to rocking axis 15) is generated in the substantially orthogonal corners 30-33. It can take considerable time to mix the contents of mixing bag 20 to homogeneity in the structure of bag 20. The mixing time can be reduced by increasing the rocking speed, but this puts more stress on the bag leading to possible breakage and also increases the energy requirements for mixing.

Referring first to the embodiment shown in FIG. 4 a flat “pillow-style” mixing bag 20A bounded by seams 49, containing components, at least one of which is a liquid, to be mixed. Mixing bag 20A or a bag or a flexible container is placed on a rocking platform 10, which pivots about a moveable or rocking axis 15. Corner 42A of the mixing bag 20A, is contoured in the same manner as the diagonally opposite corner 46A an arc that forms these corners can have a radius ranging from ¼ to ½× the width of the mixing bag 20A, but is different from adjacent corner 44A which is contoured in the same manner as its diagonally opposite corner 48A with another arc radius ranging from 1/20 to ¼ the mixing bag 20A. The corners 42A and 46A are baffles or flow directors formed at the juncture of the side walls 52, 54 and the end walls 56, 58. These baffles or flow directors force the liquid in the bag to follow the contour as the liquid cannot pass through liquid-tight seam 49 formed by joining the top sheet 22 to bottom sheet 24. The corners form a juncture of the side and end walls, which is transverse to the single axis of rocking 15 to induce a circulatory swirling motion of the liquid in the chamber, as depicted in FIG. 4, when the mixing bag is rocked. The liquid may consist of soluble powders in liquid, low or highly viscous liquids that are desired to be mixed or blended together. For the bag 20A, the junctures are oblique and arcuate. (The oblique junctures have obtuse angles of 90 degrees plus while the arcuate junctures have angles of less than 90 degrees.

The effect of this asymmetry of mixing bag 20A is that as it is tipped towards 100 by tilting support 10, liquid flows due to gravity from edge 54 towards edge 52. As the liquid approaches edge 52 it is diverted right towards the center of the mixing bag 20A by corner 42A. Liquid on the opposite side flows into corner 44A which not shaped so as to divert flow to the center. This imbalance of flow velocities forces flow from the left end wall 58 to the right end wall 56, and flow from the right end is inhibited from entering the left end. On the reverse stroke, support 10 tilts towards 101, and the liquid in mixing bag 20A flows from edge 52 towards edge 54. Liquid entering corner 46A is diverted to the center of container 20 due to the shape of corner 46A, while liquid entering corner 48A is not diverted towards the center. After 2 to 5 few rocking strokes a self sustaining motion develops as shown by the fluid streamlines 40C with the liquid in the bag 20A circulating counter-clockwise. This self-sustaining motion persists as long as the rocking motion is continued. This circulatory motion is superposed on the back and forth motion and is very effective at mixing fluid parallel to the rocking axis 15, a major limitation with prior art. The circulatory motion can easily be reversed to the clockwise direction by interchanging the geometry of the corners.

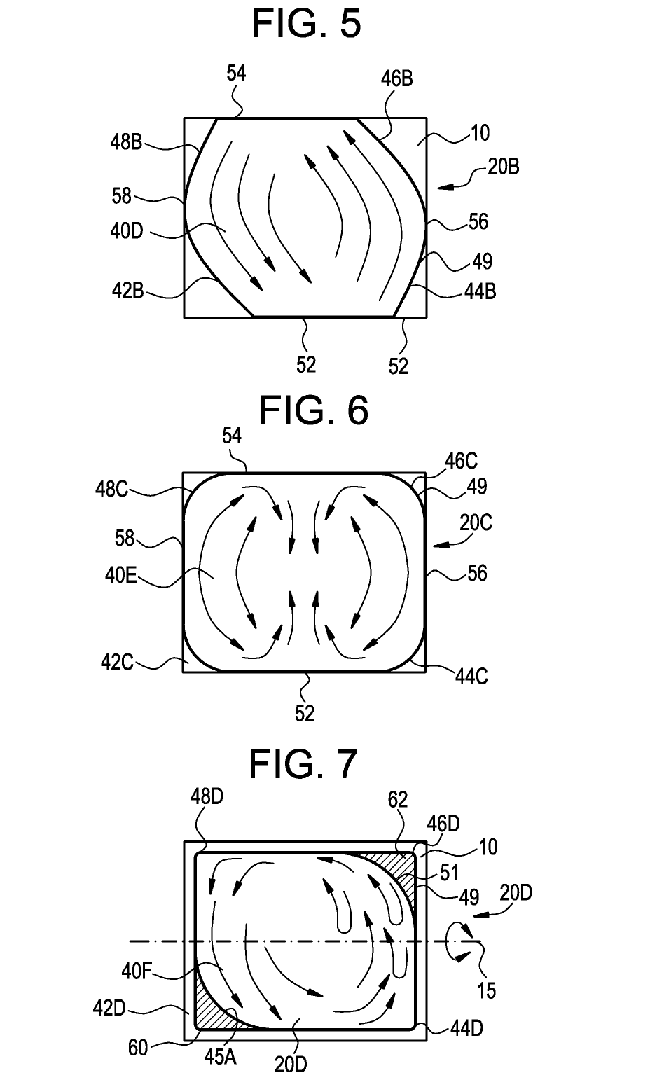

FIG. 5 shows a mixing bag 20B which produces a greater circulation than in mixing bag 20A. This is because the radius of the corners 42B and 46B is larger that their counterparts 42A and 46A (FIG. 4). The radius of these corners can range from ½ to 2× the width of the mixing bag 20B. Corners 44B and 48B also have a larger radius (¼ to ½ the mixing bag width) than their counterparts 44A and 48A (FIG. 4). These larger radius arcs provide a more gentle flow pattern, reducing some of the turbulence caused by the sharp corners 44A and 48A The resulting circulation is shown as 40D. It is critical that asymmetry of the adjacent corners be maintained. For example, the symmetrical mixing bag 20C shown in FIG. 6 has small equal arcuate corners 42C through 48C. The resulting circulation 40E is essentially a back and forth motion similar to prior art with little or no fluid parallel to the rocking axis 15.

The flow contours can be molded in the bag as curved surfaces or fabricated by seaming sections of plastic. The contours may be curved seams, or manufactured as a series of straight line seam segments. The seams are made by welding together the top and bottom sheet. Various methods—heat sealing, ultrasonic etc are commonly used. Straight seams can be easily made by inexpensive thermal bar sealers. Curved seams are much more difficult and are typically made using heated platens. These are expensive and designed for specific bag sizes. The laser method has the advantage that any shape seam, bag geometry or size can be made by just changing the software.

FIG. 7 depicts an embodiment where the flow diversion contours or baffles are inflatable segments 60 and 62, integral to the mixing bag 20D. A simple non-return valve, such as used for inflatable toys can be used with a hand pump to inflate the inflatable segments. These segments form the flow diversion contours or baffles when inflated. The resulting circulation is shown as 40F. The outer seam 49 of mixing bag 20D forms the corners 42D through 48D. All of the seams are formed when the top sheet is joined to the bottom sheet. The outer seam 49 forms the outer walls of the inflatable segments 60 and 62 and defines portions 52, 54, 56, 58 of the inner chamber of the mixing bag 20D that contains the liquid and components to be mixed. Seam 51 defines the inner wall of the inflatable segments 60 and 62. The inner wall of the inflatable segments 60 and 62, form the baffles, which are displaced from the respective corner 42D and 46D.

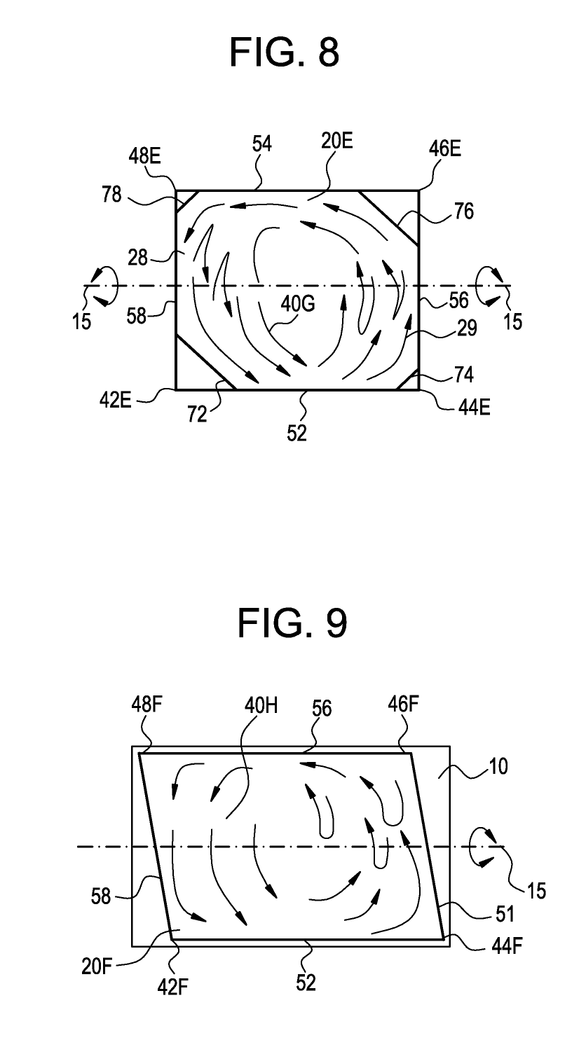

Manufacturing curved seams in bags is difficult, and requires complex equipment. Straight line seams can be easily made using commercial bar type heat sealers. The embodiment shown in FIG. 8 illustrates a mixing bag made using straight or linear seams that achieves circulation flow. The outer seam 49 forms portions 52, 54, 56, 58 of the inner chamber of the mixing bag 20E that contains the liquid and components to be mixed. Seam 51 defines the baffles 72, 74, 76, 78 as linear segments at the corners and are connected to the top, bottom, side and ends walls. These baffles are typically oriented at 45 degrees (angles from 30 to 60 degrees can be used) to the rocking axis 15. The longer baffles 42E and 46E can extend from ¼ to ⅓ of the length of the side of bag 20E and the shorter baffles 44E and 48E are typically ⅕ to ½ the length of the longer baffles. The resulting circulation of the asymmetrical baffles is shown as 40G. The corners may be removed where they extend beyond the baffles. Also the seam 49 need not extend past the juncture of the baffles, the inner seam 51, to the side and end walls.

The embodiment shown in FIG. 9 illustrates a mixing bag made using straight or linear seams that achieves circulation flow by changing the shape of mixing bag 20F from an essentially rectangular form into a trapezoidal shape. The end walls 54 and 58 of the mixing bag 20F are parallel to each other, but are not perpendicular to the side walls 52 and 56. This creates a first pair of opposed junctures and baffles 42F and 46F that are obtuse angles ranging from 100 to 130 degrees and a second pair of opposed junctures and baffles 44F and 48F that are the corresponding acute angles. By setting the obtuse angle the acute angles are automatically fixed as the shape is a parallelogram.

When the mixing bag 20F is rocked about axis 15, the fluid circulates in the direction shown by the flow streamlines 40H effectively mixing the contents of mixing bag 20F.

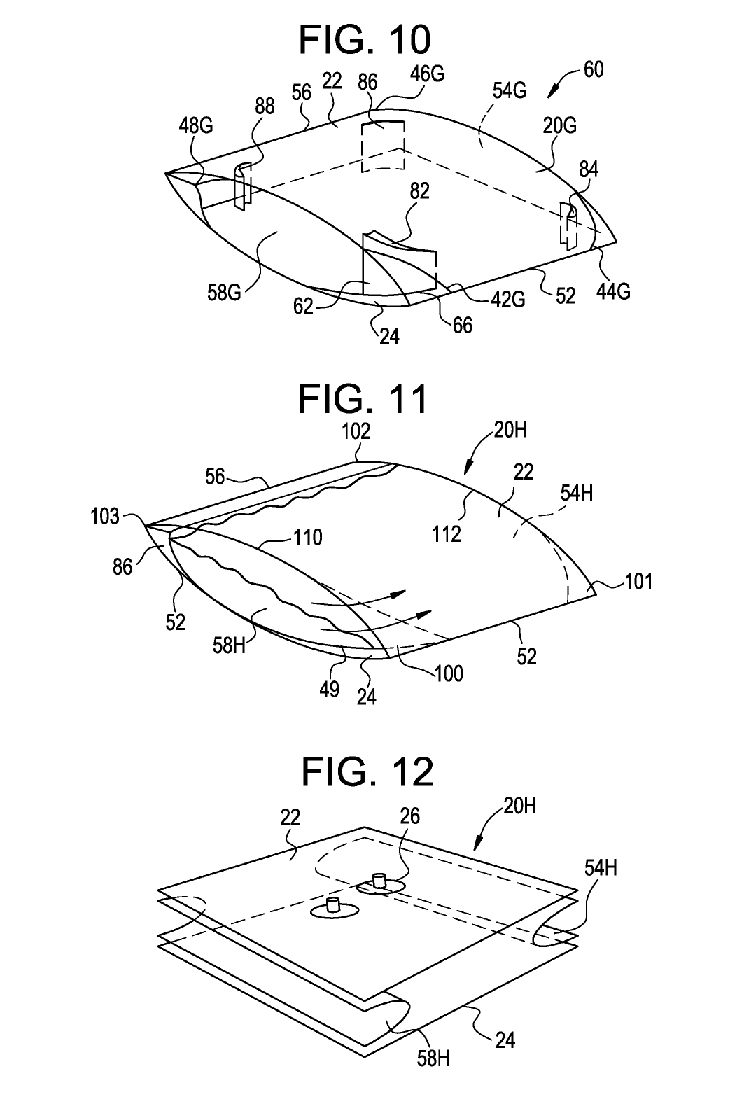

With a two dimensional bag, the baffles formed by the intersection of the side and end walls may not have sufficient height when the bag is inflated for the liquid level and rocking motion to produce the desired amount of circulation. The embodiment shown in FIG. 10 illustrates a mixing bag 20G wherein the baffles are separated and displaced from the intersection of the side and end walls. The baffles 82, 84, 86, 88 are adjacent to the corners 42G, 44G, 46G, 48G. The baffles are connected to the top wall 22, the bottom wall 24, the side walls 52, 56 and the end walls 54G, 58G. The baffles may be connected to the top and bottom walls first and then joined to the side and ends walls when they are formed or joined to the top and bottom walls.

Although the mixing bag 20G is shown in FIG. 10 as a gusseted three-dimensional bag, with triangular inserts formed at each corner, which will be discussed with respect to FIGS. 11 and 12, the baffles 82, 84, 86, 88 may be used in a two dimensional bag of the previous figures. The length and placement of baffles 82, 84, 86, and 88 should be similar to the arcuate corners discuss earlier. Also, the baffle structures of the previous figures can also be formed in a three dimensional bag.

As shown in FIG. 2 for the two dimensional bag 20, creases and wrinkles 90, 91, 92 may form on upper surface 22 of each corner 30-33, and also 93, 94 on the underside 24 of each corner 30-33 of the bag 20. Excess material may develop in corners 30-33 because the inflation pulls in unrestrained end edges 56 and 58, and pushes out corners 30-33. This excess material cannot be inflated to rigidity, and may flop around during rocking, which could lead to premature fatigue failure. The bag 20 is stressed when inflated and this stress is transmitted through top sheet 22 and bottom sheet 24 to clamped edges 52 and 56. The stress is distributed along edges 52 and 56, but not at corners 30-33 which are not pulled taut into support 10 due to the excess material present at corners 30-33. Consequently, failures can occur at corners 30-33 where the bag cannot be maintained taut and rigid.

FIG. 11 depicts a three-dimensional cell culture bag 20H formed by forming the end walls 54H and 58H as gussets on side walls 52 and 56. Culture bag 20H is formed from a multiplicity of flat flexible panels 22, 24, 54H, and 58H as depicted the exploded view shown in FIG. 12. This figure shows one way in which culture bag 20H can be formed by seaming together two flexible sheets 22 and 24, folding in two smaller panels 54H and 58H, and closing them off by a cross or curved seam 49 which bounds the inner volume of culture bag 20H. The segments of the seam 49 which joins the gusseted end walls 54H and 58H to the top sheet 22 and the bottom sheet 24 is arcuate so as to form the baffles in FIG. 11 and the end walls only in FIG. 10. The segments of the seam 49 which joins the top sheet 22 and the bottom sheet 24 forms the side walls 52 and 56.

When culture bags 20H are restrained at edges 52 and 56, and inflated, top sheets 22 and bottom sheet 24 are able to separate at the gusseted end walls 54H and 58H. The culture bag 20H conforms to the inflated three-dimension shape without wrinkles, creases, or excess corner material. Corners 100-103 are now pulled taut and provide additional structural elements that distribute stress from the high points 110 and 112 of culture bag 20H to the clamped edges 52 and 56. These edges are clamped along their entire length to holder 10, and form anchor points to restrain the bag from over inflating. The corner sections 100-103 also function as a reinforcing structure to support the bag during rocking. Rocking towards edge 56 about axis 15 causes culture bag 20H to be pulled up from edge 52. This movement is resisted by corners 100 and 101 that serve to hold culture bag 20H down. The additional tendency for the bag to slide towards edge 56 is resisted by corners 100 and 101. In the reverse stroke the same functionality is provided by corners 102 and 103.

The improved bags 20 can be a molded three-dimensional structure or fabricated by seaming flexible sheets. The edges and gusset may be curved seams, or manufactured as a series of straight line seam segments as shown herein.

This invention provides a mixing container apparatus with internal circulation that allows a user to efficiently mix soluble powders or highly viscous liquids in a mixing container. This apparatus utilizes specialized bags with baffles to provide the user with a mixing system that has a good mixing performance. Also, this apparatus allows the mixing apparatus container to preserve its hermetic integrity and does not require any type of seal where the apparatus can be easily scaled up to a few hundred liters. Thus, this invention provides the user with a simple method to mix soluble powder or viscous liquid in a mixing container that is more efficient and provides good mixing performance.

Although the present invention has been described above in terms of specific embodiments such as being for a specific bag, many modification and variations of this invention can be made as will be obvious to those skilled in the art, without departing from its spirit and scope as set forth in the following claims.

What is claimed is:

1. A mixing container apparatus comprising:
a platform placed on a moveable axis;
a flexible container, wherein the flexible container is placed on the platform, wherein the flexible container has a top wall and a bottom wall joined together to form a chamber having a portion of the top and bottom walls joined by a plurality of side walls and a plurality of end walls; and
a plurality of baffles connected to the top and bottom walls at a juncture of the plurality of side walls and the plurality of end walls being transverse to the axis, wherein the plurality of baffles are configured to induce a swirling motion of liquid in the chamber when the flexible container is moved along the moveable axis.

2. The container of claim 1, wherein the plurality of baffles each are an oblique juncture of the plurality of side walls and the plurality of end walls.

3. The container of claim 1, wherein the moveable axis is a rocking axis.

4. The container of claim 3, wherein the axis is a single axis.

5. The container of claim 4, wherein the flexible container is configured to circulate the liquid in a counter-clockwise direction.

6. The container of claim 4, wherein the flexible container is configured to circulate the liquid in a clockwise direction

7. The container of claim 1, wherein the flexible container is a bag.

8. The container of claim 3, wherein a first pair of the plurality of baffles have a first length and a second pair of the plurality of baffles have a second length shorter than the first length, wherein the plurality of baffles are configured to produce a single direction of swirling during rocking.

9. The container of claim 1, wherein the flexible container has a rectangular form.

10. The container of claim 1, wherein the flexible container has a trapezoidal shape.

11. The container of claim 1, wherein the flexible container is a three-dimensional structure.

12. A mixer comprising:
a support pivotally mounted to a base about a single axis, wherein the support is configured to be rocked about the single axis;
a bag having a top wall and a bottom wall joined by a plurality of side walls and a plurality of end walls, and a plurality of baffles connected to the top and bottom walls at the juncture of the plurality of side walls and the plurality of end walls being transverse to the single axis, wherein the plurality of baffles are configured to induce a swirling motion of liquids in the chamber when the container is rocked about the single axis; and
a clamp securing the container on the support.

13. The mixer of claim 12, wherein the bags are flexible sheets seamed together.
